(19) United States
(12) Patent Application Publication
(10) Pub. No.: US 2025/0375726 A1
(43) Pub. Date: Dec. 11, 2025

(54) HYDROCYCLONE FOR SEPARATING SOLIDS AND/OR LIQUIDS FROM A GASEOUS PROCESS STREAM

(71) Applicant: ESTA Apparatebau GmbH & Co. KG, Senden (DE)

(72) Inventors: Michael Novosel, Nattheim (DE); Maik Hermann, Elchingen (DE); Johann Paul Hahn, Dietenheim (DE)

(73) Assignee: ESTA Apparatebau GmbH & Co. KG, Senden (DE)

(21) Appl. No.: 18/874,733

(22) PCT Filed: Jun. 12, 2023
(86) PCT No.: PCT/EP2023/065650

§ 371 Date: Dec. 13, 2024

(30) Foreign Application Priority Data
Jun. 14, 2022 (DE) 10 2022 114 899.8
Jun. 14, 2022 (EP) 22178979.5

(51) Int. Cl. B01D 45/06; B01D 45/12; B01D 47/02; B01D 50/40

(52) U.S. Cl. CPC B01D 45/06; B01D 45/12; B01D 47/02; B01D 50/40

(57) ABSTRACT

A hydrocyclone for separating solids and/or liquids from a gaseous process stream includes a circumferential wall defining a process chamber having a cylindrical shaped first process chamber section. A lower region of the process chamber is designed to be filled with a process liquid up to a fill level. An inlet port defined in the circumferential wall in the lower region of the process chamber that is configured to permit the process stream to enter the process chamber in the circumferential direction of the process chamber. An outlet is defined in the upper end of the process chamber and configured to discharge the process flow from the process chamber therethrough. A guide extends in the process chamber coaxially with the circumferential wall, and is configured to guide the process stream in a helical shape between the inlet port and the outlet. A hydrocyclone assembly includes a hydrocyclone and a trough.

### TECHNICAL FIELD

The present invention relates to a hydrocyclone for separating solids and/or liquids from a gaseous process stream. The present invention also relates to a hydrocyclone arrangement comprising such a hydrocyclone and a process liquid trough.

### BACKGROUND OF THE INVENTION

In hydrocyclones, which are known in principle from the prior art, a gaseous process stream is guided along a helical trajectory in order to carry solid particles and/or liquid droplets contained in the gas stream radially outwards. In this case, a process liquid is introduced into the process stream or into certain areas of the hydrocyclone in order to bind the solid particles and/or liquid droplets for easier separation and/or to agglomerate them for better separation. For example, it is known that the process liquid is swirled up by the process stream or is sprayed in a hydrocyclone designed as a cyclone scrubber.

A disadvantage of known hydrocyclones is that the process stream is subject to a high pressure loss. Furthermore, a desired degree of separation can only be achieved over a very narrow range of volume flows. If the volume flow of the process stream changes or fluctuates, solid particles and/or liquid droplets can pass through the hydrocyclone. Furthermore, there is the problem that process liquid is discharged from the hydrocyclone together with the process stream and potentially damages downstream plant components, such as further filter stages. Finally, depending on the type of process stream, known hydrocyclones tend to become contaminated, which has a negative influence on the degree of separation and the pressure loss, and requires extensive cleaning procedures. This problem occurs, for example, when separating aluminum abrasive wear from process air, since the aluminum particles or agglomerates thereof adhere to the walls of the hydrocyclone.

### DESCRIPTION OF THE INVENTION

In view of this situation, it is an object of the present invention to propose a hydrocyclone that does not suffer from at least one of the aforementioned problems. In particular, it is an object of the present invention to propose a hydrocyclone with low pressure loss and a high degree of separation.

The object of the invention is achieved by the features of the independent main claims. Advantageous embodiments are provided in the subclaims. If technically possible, the teachings of the subclaims can be combined as desired with the teachings of the main and subclaims.

Advantages of the claimed aspects of the invention are explained below and, further below, preferred modified embodiments of the aspects of the invention are described. Explanations, in particular regarding advantages and definitions of features, are essentially descriptive and preferred, but not limiting, examples. If an explanation is limiting, this is explicitly mentioned.

According to a first aspect of the invention, the object is achieved by means of a hydrocyclone for separating solids and/or liquids from a gaseous process stream, comprising a process chamber formed by a circumferential wall and configured cylindrically in a first process chamber section, wherein an axial direction of the process chamber extends vertically and a lower region of the process chamber is provided for filling with a process liquid up to a fill level, an inlet port penetrating the circumferential wall in the lower region of the process chamber for introducing the process stream in the circumferential direction of the process chamber, an outlet arranged at an upper end of the process chamber for discharging the process stream, and a guide means extending coaxially to the circumferential wall in the process chamber for guiding the process stream in a helical shape between the inlet port and the outlet.

A hydrocyclone is understood to mean a device in which a separating force is generated which acts on solids and/or liquids contained in a process stream by guiding a mainly gaseous process stream along a helical trajectory, and in which the solids and/or liquids are separated. Here the separation takes place by radially discharging the solids and/or liquids. In this case, the solid and/or liquid is brought into contact with a process liquid such as water, in order to bind solid particles and/or liquid droplets and/or to agglomerate them for better separation by centrifugal forces. A helical shape is also and in particular understood to mean a helical shape with an outer diameter that tapers at least in some areas.

In a hydrocyclone, for example, dusts, chips and/or abrasion, as well as lubricant or coolant droplets, for example from a mechanical machining process, can be separated from a gaseous process stream such as an air or inert gas stream. In particular, the hydrocyclone is also used with combustible or explosion-prone solids and/or liquids in the process stream in order to reduce the risk of fire or explosion compared to a separator without process liquid.

The flowing fluid disposed at a particular point in the hydrocyclone is referred to as the process stream, regardless of whether only the gas itself or also solids and/or liquids, in particular process liquid, are present in the process stream at this point. The respective composition of the process stream along its trajectory in the hydrocyclone is respectively evident from the context. Insofar as the process stream is described as gaseous, this refers to a completely purified process stream and is not to be understood as restrictive with regard to a loading with solids and/or liquids, in particular the process liquid.

A circumferential wall is understood to be a wall that forms a geometric envelope of such a helical shape. The circumferential wall is formed cylindrical in the first process chamber section, i.e. it has a round cross-section and defines a cylindrical coordinate system with an axial direction, a radial direction and a circumferential direction. Overall, the hydrocyclone is coaxially constructed around this cylindrical coordinate system in its essential components.

Insofar as an inlet port is arranged in the lower region of the process chamber, it is located at no or only a small distance from a lower end of the first process chamber section compared to the total axial extent of the first process chamber section. In particular, an intended fill level of the process liquid lies within the axial extent of the inlet port, so that process liquid filled into the first process chamber section also stands in the inlet port. A process stream supply to the inlet port then preferably occurs from above, so that no process liquid can reach components of a plant that are located upstream of the hydrocyclone. Furthermore, an intended fill level preferably has a ratio of between 0.3 and 0.6, preferably between 0.4 and 0.5, and in particular 0.45, to the axial length of the first process chamber section.

The first aspect of the invention includes the teaching that the process stream entering the process chamber swirls up process liquid filled in the lower region of the process chamber, so that the process liquid forms a process liquid curtain arranged essentially radially outward in the process chamber. In particular, the process liquid forms a curtain that is parabolic in cross section with a center axis arranged coaxially with the axial direction. Solid particles and/or liquid droplets contained in the process stream are then carried radially outwards in the helical trajectory that the process stream forms in the process chamber and come at the latest there into contact with the process liquid curtain, so that solid particles and/or liquid droplets are bound in the process liquid and/or are agglomerated by centrifugal forces for better separation.

The provision of a guide means ensures that the process stream is guided in its helical form, so that turbulences and thus the flow resistance over the helical trajectory of the process stream are reduced. This ensures that the hydrocyclone as a whole has a reduced pressure loss compared to a hydrocyclone without a guide means. The guide means extends into the lower region of the process chamber and is immersed in the process liquid filled into the process chamber. Preferably, the guide means extends axially to a lower end of the first process chamber section. On the other hand, the guide means preferably extends axially to an upper end of the process chamber. The cross-section of the first process chamber section is thus restricted from a circular shape to a circular ring shape where the guide means extends and is thus restricted and reduced in size to the area that is actually occupied by the helical trajectory. Furthermore, by immersing the guide means in the process liquid, the surface of the process liquid is also restricted from a circular shape to a circular ring shape. In this way, a reduced pressure loss is also achieved by swirling up the process liquid to form the process liquid curtain, in that the turbulences at the process liquid is reduced compared to a hydrocyclone without a guide means. Moreover, the required amount of process liquid that has to be filled into the hydrocyclone is reduced.

Furthermore, surprisingly, a significantly increased degree of separation is achieved through the use of a guide means, wherein an increased degree of separation is also achieved over an increased range of volume flows. The hydrocyclone therefore maintains a high degree of separation and a low pressure drop even when the volume flow of the process stream changes or fluctuates, wherein the breakthrough, i.e. the amount of solid and/or liquid that passes through the hydrocyclone, is reduced compared to a hydrocyclone without a guide means. For example, with an average particle size of solid particles contained in the process stream of 1 micrometer, a degree of separation of greater than 90% can be achieved.

Preferably, the guide means is formed at least in sections in a cylindrical shape, but it can also have other, in particular several different cross-sectional geometries. If the guide means is formed cylindrical, it preferably has a diameter which has a ratio of between 0.2 and 0.8, preferably between 0.3 and 0.7, particularly preferably between 0.4 and 0.6 and in particular 0.5, to the diameter of the circumferential wall.

In a preferred embodiment, the first process chamber section is followed at the top by a second process chamber section formed by a circumferential wall section converging conically towards the outlet. The trajectory of the process stream then accordingly conically converges in the second process chamber section, wherein the process liquid curtain, which is entrained radially outward at the helical trajectory, is decelerated at the conical circumferential wall section and is subsequently at least partially separated from the stream and flows back along the circumferential wall into the lower region of the process chamber. The process liquid is thus separated from the process stream again after binding or agglomeration of solids and/or liquids and remains in the hydrocyclone. The diameter of the outlet formed by the conical circumferential wall section has a ratio of between 0.4 and 0.8, preferably between 0.5 and 0.7 and in particular 0.6, to the diameter of the first process chamber section.

Further preferably, the guide means extends over the entire axial length of the first process chamber section. Particular preferably, the guide means also extends over the entire axial length of the second process chamber section. In this way, a guidance of the helical trajectory over the entire process chamber is achieved, so that the hydrocyclone has a particularly low pressure loss.

It is also preferred if the guide means has a conically upwardly converging guide means section at an upper end. Such a guide means section then corresponds with the conically converging circumferential wall section, so that the clear cross-section of the second process chamber section is not changed or only slightly changed with respect to the clear cross-section of the first process chamber section. Particularly preferably, the conically converging guide means section and the conically converging circumferential wall section extend parallel to one another. Also preferably, the conically converging guide means section extends axially over the entire axial length of the second process chamber section.

In a particularly preferred embodiment, the hydrocyclone comprises a roof element arranged above the outlet for deflecting the process stream downwards, wherein the roof element is formed pot-shaped with a bottom and a cylindrical side wall extending downwards from the bottom. The process stream emerging from the outlet essentially upwards then flows against the bottom of the roof element and is forcibly deflected downwards there. The process stream then escapes from the roof element in a gap between the side wall and the circumferential wall, wherein a gap surface normal preferably has a substantially radial orientation. As a result of the deflection at the roof element, the flow in the gap has a downwardly directed flow direction component. Preferably, the process stream is then diverted upwards immediately after emerging from the gap. This ensures that solid particles, liquid droplets and/or process liquid still contained in the process stream continue to move downwards by inertia, while the purified gaseous part of the process stream is diverted upwards. The solid particles, liquid droplets and/or process liquid thus cannot follow a sudden deflection of the process stream and are separated. Due to the downward component of motion of the process liquid still contained in the process stream, a process liquid curtain is again generated at the gap, through which the remaining process stream flows, so that still unbound solid particles and/or liquid droplets are again or for the first time brought into contact with the process liquid and are bonded there. A hydrocyclone with a roof element consequently has an improved degree of separation compared to a hydrocyclone without a roof element. Discharge can be achieved or enhanced, for example, by suction.

Preferably, the roof element and the first process chamber section are arranged spaced apart from one another in the axial direction by the gap. Further preferably, the roof element and the second process chamber section are arranged spaced apart from one another in the axial direction by the gap. However, it is preferably provided, that the gap and the second process chamber section at least partially overlap in the axial direction. An outer side of the conical circumferential wall section then forms a guide surface for the process stream at the gap, which corresponds in its orientation to the desired flow direction of the process stream at the outlet from the gap obliquely downwards. The flow can then also develop in the area of the gap with a particularly low pressure loss. The height of the gap preferably has a ratio of between 0.1 and 0.5, preferably between 0.2 and 0.4 and in particular 0.3, to the axial length of the first process chamber section.

Furthermore, the bottom of the roof element is also preferably formed to converge conically upwards. The deflection of the process stream emerging from the outlet then occurs in a direction extending obliquely downwards, which corresponds to the desired flow direction at the gap. Thus, no further deflection is necessary between the roof element and the gap, so that overall a low pressure loss is achieved.

In one embodiment, moreover, the side wall comprises a collar for guiding the process stream when it is deflected upwards as it emerges from the roof element. The abruptly upwardly deflected part of the process stream can then flow along the collar with little turbulence and thus with little pressure loss.

Further preferably, the roof element is held at the guide element by a fastening means. The fastening means then extends preferably coaxially with the guide means and thus in the center of the helical flow trajectory. The fastening means is thus not arranged in a direct flow path of the process stream and thus does not contribute to a further pressure loss of the process stream. In addition, the fastening means provides for an overall compact hydrocyclone.

Overall, the aforementioned design provides a hydrocyclone which can be easily disassembled and in which the roof element can be removed by loosening the fastening means and sufficient access to the process chambers is created through the then open outlet. Alternatively or in addition, the conically converging circumferential wall section can also be formed to be easily disassembled. The hydrocyclone is thus particularly easy to access for cleaning. In particular, it is not absolutely necessary to empty the process liquid from the first process chamber section for cleaning, although this is still possible.

In a further embodiment, the guide means is configured to be variable in cross-section at least over a part of its axial extent. This means that the cross-sectional area of the guide means can be changed in size, for example, while maintaining the same geometry, that the geometry itself can be changed, or that a cross-section of the guide means can be shifted, for example, transversely to the axial direction. In this way, the guide means can be adapted to a respective process stream in such a way that the operating parameters are optimized for this process stream. For example, a particular favorable ratio between a low pressure loss and a high degree of separation can be set. The hydrocyclone can be used in this way for a variety of process streams.

Furthermore, with a variably configured guide means, it is also possible for the cross-section to be adjusted during operation by a control unit or a regulator to follow a process stream that is changing in at least one characteristic. For example, the process stream can change in its volumetric flow, its mass flow or in its composition, in particular with regard to solids or liquid loading. The characteristics of the process stream are then, for example, detected by sensors and evaluated, wherein an ideal guide means cross-section is calculated by means of data processing means and adjusted by means of control means at the guide means.

For example, the guide means is configured to be elastic, wherein an interior space of the guide means is designed to be variable in volume in order to change the cross-section of the guide means. Alternatively, the hydrocyclone can also comprise means for compressing and/or stretching the guide means in order to change the cross-section of the guide means.

In a further preferred embodiment, at least one wall section of the circumferential wall has a sufficiently low modulus of elasticity to avoid adhesions at the wall section by means of elastic deformation of the wall section. Avoiding adhesions is understood to mean both preventing the adhesion of solids and/or liquids and removing adhesions that already exist. Adhesion occurs, for example, when solids and/or liquids, in particular solid agglomerates generated by the process liquid, are held mechanically or when there is another binding force between the solids and/or liquids and the circumferential wall, for example an electrostatic, magnetic or chemical binding force.

In the wall section, the circumferential wall thus has a combination of material and geometry that allows the wall section to be elastically deformed without being damaged, in particular without being plastically deformed. Such a deformation is possible to an extent that allows adhesions to be removed at an inner side of the wall section. Thus, as a result of the deformation, a relative movement is generated between the wall section and the adhesion, by means of which a binding force between the adhesion and the wall section is released or overlapped. In particular, adhesions are accelerated away from the wall section in the course of the deformation. The relative movement can also be designed in such a way that it is more difficult or even impossible for an adhesion to adhere to the wall section, for example by deforming the wall section periodically at a sufficiently high frequency. The aforementioned design of the hydrocyclone makes it possible to avoid adhesions, in particular to prevent it from occurring and/or, if it does occur, to remove it from the wall section without requiring an interrupt of the operation of the hydrocyclone. For example, to this end, the wall section can be deformed from the outside, for example at certain regular intervals. In the simplest case, the hydrocyclone can be deformed manually from the outside, but preferably corresponding means, in particular automated means, can be provided for this purpose. Deforming the wall section preferably enables to avoid adhesions in a very simple way. Furthermore, an elastically designed wall section results in reduced noise emission during operation of the hydrocyclone.

In yet another embodiment, an inner side of the circumferential wall facing one or both of the process chambers is configured at least partially electrically conductive and grounded. This prevents electrically charged solid particles from adhering to the wall section due to their charge and/or potential differences. In the case of a wall section made of plastic, these properties can be achieved, for example, by means of a coating.

According to a second aspect of the invention, the object is achieved by a hydrocyclone arrangement comprising a hydrocyclone according to the first aspect of the invention and comprising a process liquid trough, wherein the hydrocyclone is formed open at a lower end of the process chamber and is arranged standing in the process liquid trough. By use of the hydrocyclone arrangement essentially the advantages described above with regard to the first aspect of the invention can be achieved accordingly. In particular, the hydrocyclone arrangement has a high degree of separation and a low pressure loss.

Here, the trough preferably extends radially outwards beyond the circumferential wall and thus forms an overhang with respect to the hydrocyclone. In this way, process liquid that escapes from the gap also returns to the trough, for example in free fall or along the outside of the circumferential wall. In particular, a circumferentially formed trough wall extends upwards at radially outer ends, thus forming a housing around the hydrocyclone. The process liquid is then particularly advantageously held within the housing thus formed and is safely returned to the trough.

In a preferred embodiment of the second aspect of the invention, a discharge means, in particular a suction means, for discharging the process stream is arranged above the roof element. In particular, a housing formed by the trough wall can also extend horizontally above the hydrocyclone with a housing cover, wherein the housing cover is penetrated by a discharge port, in particular a suction port. The process stream emerging from the gap is then abruptly deflected upwards immediately outside the gap, i.e. outside the hydrocyclone, and the solids and/or liquids contained therein are separated as described above. The hydrocyclone arrangement then has a particularly high degree of separation, wherein process liquid is also reliably separated from the process stream again. Components of a plant, such as further filter stages, which are arranged downstream of the hydrocyclone arrangement, are then not reached by solids and/or liquids, in particular the process liquid. Insofar as the housing comprises a housing cover, the hydrocyclone is completely enclosed and it is completely avoided that in particular liquids escape to the environment of the hydrocyclone arrangement.

In one embodiment of the hydrocyclone arrangement, this comprises several hydrocyclones, wherein the several hydrocyclones are arranged in the same process liquid trough or the same housing. In this way, the volume flow can be multiplied in comparison to a hydrocyclone arrangement comprising only one hydrocyclone, in particular without increasing the differential pressure. The hydrocyclone arrangement is scalable in this respect by connecting any number of hydrocyclones in parallel in a simple manner. It is also possible to operate several hydrocyclone arrangements with their own process liquid troughs or housings in parallel with the same effect.

### BRIEF DESCRIPTION OF THE DRAWINGS

In the following, the invention will be explained in more detail with reference to the attached drawings on the basis of preferred exemplary embodiments. The term figure is abbreviated as Fig. in the drawings.

In the drawings:

FIG. 1 shows a schematic cross-sectional view of a hydrocyclone according to the first aspect of the invention according to a preferred exemplary embodiment;

FIG. 2 shows a schematic cross-sectional view of a hydrocyclone arrangement according to the second aspect of the invention with a hydrocyclone according to FIG. 1; and

FIG. 3 shows a perspective view of the hydrocyclone according to the first aspect of the invention as shown in FIG. 1.

### DETAILED DESCRIPTION OF THE DRAWINGS

The described exemplary embodiments are only examples, which can be modified and/or supplemented in a variety of ways within the scope of the claims. Each feature described for a particular exemplary embodiment can be used independently or in combination with other features in any other exemplary embodiment. Each feature described for an exemplary embodiment of a particular claim category can also be used in a corresponding manner in an exemplary embodiment of another claim category.

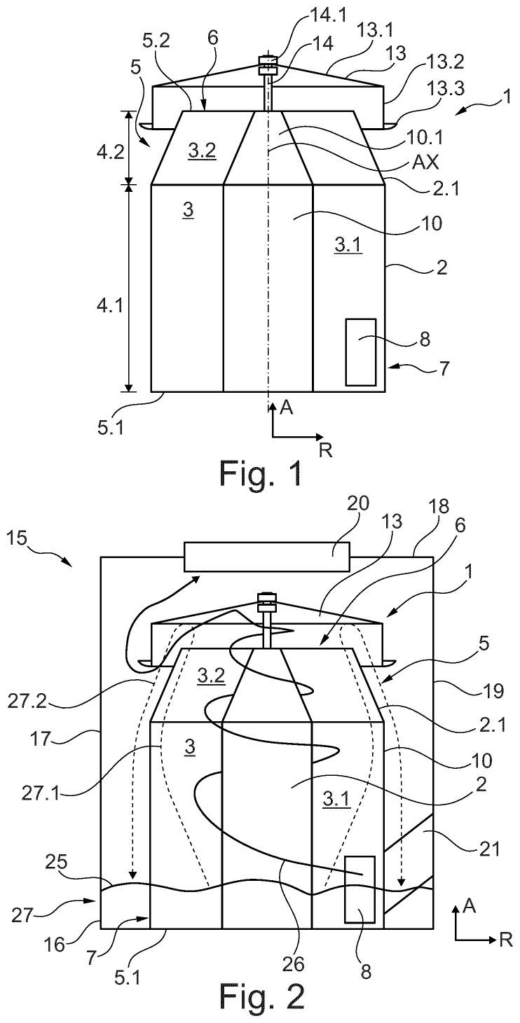

FIG. 1 shows a hydrocyclone 1 according to the first aspect of the invention, comprising a circumferential wall 2, wherein a process chamber 3 is enclosed by the circumferential wall 2. The process chamber 3 spans around its center axis AX a cylindrical coordinate system with an axial direction A, a radial direction R and a circumferential direction not shown in detail, wherein the axial direction A is oriented vertically. The process chamber 3 also has a cylindrically formed first process chamber section 3.1 and a conically formed second process chamber section 3.2 adjoining it at the top, wherein the first process chamber section 3.1 extends over a first axial length 4.1 and the second process chamber section 3.2 extends over a second axial length 4.2. The second process chamber section 3.2 is thus formed by a conically converging circumferential wall section 2.1. The process chamber 3 also has a lower end 5.1 and an upper end 5.2, wherein an outlet 6 is arranged at the upper end 5.2. In a lower region 7 of the process chamber 3, the circumferential wall 2 is penetrated by an inlet port 8.

A guide means 10 is arranged coaxially with the center axis AX in the process chamber 3, which guide means is configured cylindrically in the first process chamber section 3.1 and has a conically converging guide means section 10.1 in the second process chamber section 3.2. The guide means 10 is thus configured parallel to the circumferential wall 2 in the entire process chamber 3 and serves to guide a helical flow of a process stream entering the process chamber 3 through the inlet port 8, as described in more detail below with respect to FIG. 2.

A roof element 13 is arranged above the outlet 6 and is held at the guide means 10 by means of a fastening means 14. More precisely, the roof element 13 is held on the fastening means 14 by means of screw nuts 14.1. The roof element 13 has a bottom 13.1 and a downwardly extending cylindrical side wall 13.2 and is thus configured generally pot-shaped. The bottom 13.1 is designed to converge conically towards the top. Furthermore, the roof element 13 comprises a collar 13.3 at the side wall 13.2. The roof element 13 forms together with the circumferential wall 2 a gap S, which extends in the axial region of the second process chamber section 3.2. The second process chamber section 3.2 thus projects into the roof element 13. A surface normal of the gap S is oriented radially outwards.

FIG. 2 shows a hydrocyclone arrangement 15 according to the second aspect of the invention and in addition the flow conditions prevailing in the hydrocyclone 1 or the hydrocyclone arrangement 15, on the basis of which the function of the hydrocyclone 1 or the hydrocyclone arrangement 15 is explained in more detail.

The hydrocyclone arrangement 15 comprises a hydrocyclone 1 which has already been described and a repeated description thereof is dispensed with. The hydrocyclone arrangement 15 also comprises a process liquid trough 16, from which a trough wall 17 extends upwards. The process liquid trough 16, the trough wall 17 and a housing cover 18 provided at the upper end of the trough wall 17 together form a housing 19. A discharge means 20 is recessed into the housing cover 18, which may in particular be designed as a suction means. Furthermore, a process stream supply 21 which supplies a process stream from above to the inlet port 7 is provided in the housing 19 or passing through the housing 19.

The process chamber 3 is configured open at its lower end 5.1 and stands in the process liquid trough 16. The process liquid trough 16 and thus also the process chamber 3 are filled up to a fill level 25 with a process liquid 27, in particular water. The fill level 25 extends up to a certain height of the inlet port 8, so that the process liquid 27 partially covers the inlet port 8. A process stream 26, which is initially gaseous and is loaded with non-desirable solids and/or liquids, flows in the process chamber 3 along a helical trajectory and is guided by the guide means 10, wherein the process stream 26 enters the process chamber 3 in a circumferential direction through the inlet port 8. In this case, the process stream 26 swirls up a process liquid curtain 27.1, which is formed in a parabolic shape in the first process chamber section 3.1, from the process liquid 27. The process liquid curtain 27.1 is then located radially at the outside in the process chamber 3 and serves to ensure that solids and/or liquids contained in the process stream 26, which are carried radially outwards in the process chamber 3 by the centrifugal force, come into contact with the process liquid 27 in order to become bonded and/or agglomerated.

In the second process chamber section 3.2, both the helical trajectory of the process stream 26 and the process liquid curtain 27.1 are narrowed in the conically converging circumferential wall 2. In this case, part of the process liquid 27 is already separated from the process stream 26 and flows back along the inside of the circumferential wall 2 into the process liquid trough 16.

The process stream 26 and the remaining process liquid 27 exit at the outlet 6, mainly oriented upwards, and hit the bottom 13.1 of the roof element 13. There they are each deflected downwards and then flow to the gap S. At the gap S, the process stream 26 is abruptly deflected upwards to the discharge means 20 and guided by the collar 13.3 to avoid turbulence. The process liquid 27 cannot follow this deflection and therefore leaves the gap S oriented downwards. In the gap S, the process liquid 27 forms a further process liquid curtain 27.2, through which the process stream 26 flows transversely, so that solids and/or liquids still contained in the process stream 26 are bonded at the process liquid curtain 27.2.

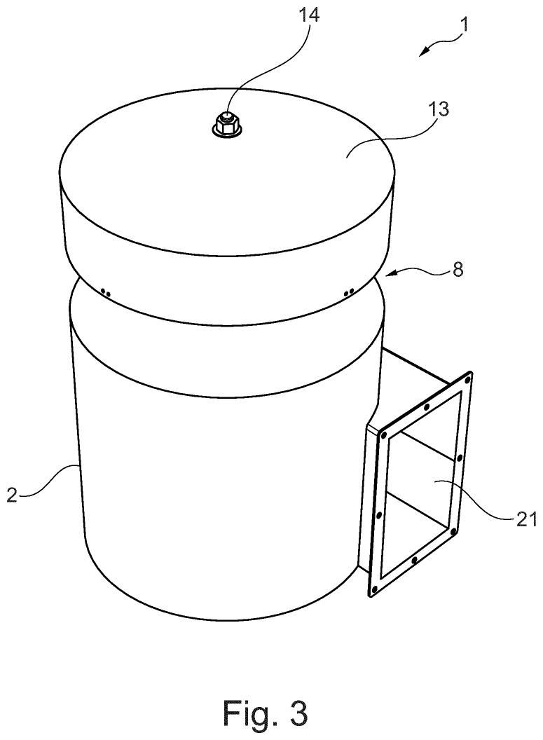

FIG. 3 shows the hydrocyclone 1 again in perspective view from the outside, wherein the elements of the hydrocyclone 1 shown already result from the description above and are therefore not described again.

### LIST OF REFERENCE SYMBOLS

1 hydrocyclone
2 circumferential wall
2.1 conically converging process chamber section
3 process chamber
3.1 first process chamber section
3.2 second process chamber section
4.1 first axial length
4.2 second axial length
5.1 lower end of the process chamber
5.2 upper end of the process chamber
6 outlet
7 lower region of the process chamber
8 inlet port
10 guide means
10.1 conically converging guide means section
13 roof element
13.1 bottom of roof element
13.2 cylindrical side wall of roof element
13.3 collar of roof element
14 fastening means
14.1 screw-nut
15 hydrocyclone arrangement
16 process liquid trough
17 trough wall
18 housing cover
19 housing
20 discharge means
21 process stream supply
25 fill level of process liquid
26 process stream
27 process liquid
27.1 process liquid curtain
27.2 process liquid curtain
A axial direction
AX center axis
R radial direction
S gap

1.-15. (canceled)

16. A hydrocyclone for separating solids and/or liquids from a gaseous process stream, comprising:
a circumferential wall defining a process chamber and a vertically extending axial direction, the process chamber having a first cylindrical process chamber section and a lower region configured to be filled up to a fill level with a process liquid;
an inlet port defined in the circumferential wall in the lower region of the process chamber and configured to introduce a process stream into the process chamber in a circumferential direction of the process chamber;
an upwardly directed outlet defined in an upper end of the process chamber and configured to discharge the process stream; and
a guide disposed within the process chamber and extending coaxially with the circumferential wall, and configured to guide the process stream in a helical shape from the inlet port to the outlet port.

17. The hydrocyclone of claim 16, wherein the circumferential wall includes a circumferential wall section that both converges conically toward the outlet and defines a second process chamber section disposed above and adjoining the first process chamber section.

18. The hydrocyclone of claim 16, wherein the guide extends an entire axial length of the first cylindrical process chamber section.

19. The hydrocyclone of claim 16, wherein the guide extends an entire axial length of the process chamber.

20. The hydrocyclone of claim 16, wherein the guide comprises a guide section disposed at an upper end thereof that conically converges in an upward direction.

21. The hydrocyclone of claim 20, wherein the guide section extends the entire axial length of the of the second process chamber section.

22. The hydrocyclone of claim 16, further comprising:
a pot-shaped roof having a bottom and a cylindrical sidewall extending downward from an outer periphery of the bottom, the roof being disposed above the upwardly directed outlet and configured to deflect the process stream in a downward direction after the process stream exits the process chamber through the outlet.

23. The hydrocyclone of claim 22, wherein the roof and the first cylindrical process chamber section are spaced apart from each another in the axial direction by a gap.

24. The hydrocyclone of claim 23, wherein the gap and the second process chamber section at least partially overlap in the axial direction.

25. The hydrocyclone of claim 22, wherein the bottom of the roof converges conically upwards.

26. The hydrocyclone of claim 22, wherein the sidewall comprises a collar configured to guide the process stream at an upward deflection as it emerges from the roof element.

27. The hydrocyclone of claim 22, wherein the roof is secured at the guide by a fastening means.

28. The hydrocyclone of claim 16, wherein the guide has a variable cross-section over at least a part of its axial length.

29. The hydrocyclone of claim 16, wherein at least one wall section of the circumferential wall has a sufficiently low modulus of elasticity to avoid adhesions on the wall section by elastic deformation of the wall section.

30. A hydrocyclone assembly, comprising:
a process liquid trough; and
the hydrocyclone of claim 16 disposed within the process liquid trough and configured to be open at a lower end of the process chamber.

31. The hydrocyclone assembly of claim 30, further comprising:
a suction means disposed above the roof and configured to discharge the process stream.
